(19) United States
(12) Patent Application Publication
(10) Pub. No.: US 2013/0300017 A1
(43) Pub. Date: Nov. 14, 2013

(54) FOAMED ELASTIC BODY, METHOD OF MANUFACTURING THE SAME, AND CONDUCTIVE ROLL FOR ELECTROPHOTOGRAPHIC MACHINE

(71) Applicant: TOKAI RUBBER INDUSTRIES, LTD., Komaki-shi (JP)

(72) Inventors: Atsuhiro KAWANO, Kasugai-shi (JP); Kadai TAKEYAMA, Kasugai-shi (JP); Yasuhide WANTANABE, Komaki-shi (JP)

(21) Appl. No.: 13/941,268

(22) Filed: Jul. 12, 2013

Related U.S. Application Data
(62) Division of application No. 12/399,780, filed on Mar. 6, 2009.

(30) Foreign Application Priority Data
Mar. 6, 2008 (JP) JP2008-056091
Nov. 17, 2008 (JP) JP2008-292914

(51) Int. Cl. B29C 44/12

(52) U.S. Cl. CPC B29C 44/12
USPC 264/48

(57) ABSTRACT

A foamed elastic body having low hardness and excellent flatness and smoothness on the outer circumference, and imparting low hardness to the surface of a conductive roll for an electrophotographic machine, in which coating layers having various functions are coated on the outer circumference. A tube-shaped foamed elastic body has a skin layer and open foamed cells on outer and inner circumferences respectively. The body is prepared by heating and cross-linking an outer circumference of a non-cross-linked and non-foamed tube body with a shaft core inserted therein, and removing the core and heating the tube body under normal pressure. The skin layer thickness is preferably in the range of 10 to 100 μm. The body defines a base layer of a conductive roll, and an outermost layer and an intermediate layer are coated on the outer circumference of the layer.

### CROSS REFERENCE TO RELATED APPLICATIONS

This application is a Divisional of co-pending application Ser. No. 12/399,780, filed on Mar. 6, 2009, for which priority is claimed under 35 U.S.C. §120; and this application claims priority of Application No. 2008-056091 filed in Japan on Mar. 6, 2008 under 35 U.S.C. §119, the entire contents of all of which are hereby incorporated by reference.

### BACKGROUND OF THE INVENTION

1. Field of the Invention

The present invention relates to a foamed elastic body that is suitably used as a base layer of a conductive roll for an electrophotographic machine, a method of manufacturing the foamed elastic body, and a conductive roll for an electrophotographic machine.

2. Description of Related Art

Recently, electrophotographic machines using xerography such as a copier, a printer, and a fax machine have been widely used. A photosensitive drum is generally provided in the electrophotographic machines and conductive rolls such as a charging roll, a developing roll, a transfer roll, and a toner supply roll are disposed around the photosensitive drum.

In these electrophotographic machines, a contact charging method and a contact developing method are mainly used. According to the contact charging method, the surface of a photosensitive drum is charged by making the surface of a charging roll in direct contact with the surface of the photosensitive drum. According to the contact developing method, a toner layer is formed on the surface of a developing roll using a layer forming blade, and a toner is applied to a latent image on the surface of a photosensitive drum by making the roll surface in direct contact with or in non-contact with the surface of the photosensitive drum.

In these cases, the charging roll may easily apply stress to the photosensitive drum or a residual toner that is not transferred, and the developing roll may easily apply stress to the photosensitive drum or the toner, and therefore, the image may be easily deteriorated when the hardness of the roll surface is high. Accordingly, a conductive roll having low hardness is required. In order to satisfy the requirement, a conductive roll with a base layer in a sponge shape (foamed) has been widely known.

The conductive roll is required to have several functions, in addition to low hardness. For example, a function of surface protection is required to ensure durability. Further, for example, the charging roll requires chargeability. Further, for example, the developing roll requires toner chargeability, toner releasability, residual charge attenuation, etc. In the conductive roll that requires plural functions, layers meeting the required functions are often formed on the base layer of the roll. In this configuration, it is preferable to form thinner layers by coating, to reduce influence on the hardness of the roll. In order to form such coating layers, the surface to be coated needs to be flat and smooth.

In the conductive roll with the sponge-shaped base layer, for example, a method of making a surface of the roll flat and smooth by applying a non-foamed rubber tube on the base layer (covering the base layer with a non-sponge-shaped layer) has been known.

Further, techniques of applying a skin layer on the circumference of the base layer of the roll have been known. For example, a technique is known that forms a skin layer on the outer circumference of the base layer of the roll by forming the base layer of the roll using a mold with air holes through the inner surface which mold comes into contact with the outer circumference of the base layer of the roll.

Japanese Patent Application Unexamined Publication No. Hei7-71442 discloses a technique of forming a skin layer on the outer circumference of a roll by forming air holes through a core bar of the roll and foam-molding a base layer passing through the core bar in a mold.

Japanese Patent Application Unexamined Publication No. 2003-156960 discloses a technique of forming a skin layer on the inner circumference of the base layer by performing low-temperature aging on an unvulcanized and non-foamed tube-shaped molded body that is formed by extrusion-molding silicone rubber in a tube shape, at 50 to 70° C. for 24 hours, and then vulcanizing and foaming the tube-shaped molded body by heating it.

However, according to the base layers achieved by the above methods in the related art, it is impossible to sufficiently achieve low hardness of the roll and flatness and smoothness of the surface to be coated. For example, there is a problem that hardness is increased by applying the non-foamed rubber tube on the sponge-shaped base layer.

Further, in the base layer formed by the mold having air holes through the inner surface of the mold, projections are created on the roll surface by the air holes, thereby deteriorating the flatness and smoothness of the surface. Further, when the size or the number of air holes in the mold is small, gas is not sufficiently removed, such that bubbles are also created on the skin layer and the flatness and smoothness of the surface are deteriorated.

Further, when the base layer passing through the core bar having air holes is foam-molded in a mold, since the base layer is foamed in insulation displacement contact to the core bar, a skin layer is also formed on the inner circumference, thereby increasing the hardness. In addition, by reducing the size or the number of air holes in the core bar to prevent the increase in the hardness, gas is not sufficiently removed. As a result, there is a problem that bubbles are also created on the skin layer of the outer circumference, thereby deteriorating the flatness and smoothness of the surface.

Further, in the base layer prepared by performing low-temperature aging on an unvulcanized and non-foamed tube-shaped molded body and then vulcanizing and foaming it, skin layers are formed on the inner and outer circumferences, such that the hardness increases. Further, there is a problem that when the aging is insufficient, bubbles are also created on the skin layer on the outer circumference, thereby deteriorating the flatness and smoothness of the surface.

As described above, in the base layers that are achieved by various methods in the related art, the increase in the hardness of the base layer and the unevenness of the surface of the base layer influence output images, such that bad images are produced. Therefore, there is a need to improve the base layer.

### SUMMARY OF THE INVENTION

An object of the invention is to overcome the problems described above and to provide a foamed elastic body that has low hardness and excellent flatness and smoothness on the outer circumference, imparts low hardness to the surface of a conductive roll for an electrophotographic machine when used in the conductive roll, and on the outer circumference of which coating layers having various functions can be applied. Further, another object of the present invention is to provide a method that is suitable for manufacturing the foamed elastic body. Furthermore, another object of the present invention is to provide a conductive roll for an electrophotographic machine that has excellent surface property with low hardness and increases the quality of outputted images by using the foamed elastic body.

To achieve the objects and in accordance with the purpose of the present invention, a tube-shaped foamed elastic body for a conductive roll for an electrophotographic machine has a skin layer on an outer circumference and open foamed cells on an inner circumference.

It is preferable that the thickness of the skin layer is in the range of 10 to 100 μm.

In addition, it is preferable that the foamed cells of the foamed elastic body gradually increase in diameter toward the inside in a radial direction.

In another aspect of the present invention, a conductive roll for an electrophotographic machine has the above-described foamed elastic body and a shaft body inserted in the foamed elastic body.

It is preferable that the inner diameter of the foamed elastic body is in the range of 30% to 85% of the outer diameter of the shaft body.

It is also preferable that the foamed elastic body is formed of ion conductive rubber.

It is also preferable that the shaft body is a solid body.

Yet, in another aspect of the present invention, a method of manufacturing a foamed elastic body for a conductive roll for an electrophotographic machine has the steps of forming a non-cross-linked and non-foamed tube body, forming a skin layer by cross-linking an outer circumference of the tube body, without foaming, and foaming and cross-linking a non-cross-linked portion after the step of forming the skin layer.

It is preferable that the tube body is heated, with a shaft core inserted in the tube body, in the step of forming the skin layer.

It is also preferable that the tube body is heated under pressure, in the step of forming the skin layer.

According to the foamed elastic body of the present invention having the skin layer on the outer circumference and the open foamed cells on the inner circumference, the flatness and smoothness of the outer circumference are excellent and large elasticity and low hardness are obtained. Accordingly, by using the foamed elastic body for a conductive roll, it is possible to achieve a conductive roll for an electrophotographic machine having excellent surface property with low hardness and making high-quality outputted images.

In this configuration, if the thickness of the skin layer is in the range of 10 to 100 μm, it is possible to achieve excellent effects of increasing the flatness and smoothness of the outer circumference while preventing hardness from being increased by the formation of the skin layer on the outer circumference.

Further, in the foamed elastic body, since the diameters of the foamed cells gradually increase toward the inside in the radial direction, it is possible to achieve the above effect.

On the other hand, according to the conductive roll for an electrophotographic machine of the present invention having the foamed elastic body with the open foamed cells on the inner circumference, low hardness can be achieved. Further, since the surface property is also excellent when the coating layers having various functions are coated on the outer circumference of the foamed elastic body, it is possible to achieve high-quality output images.

In this configuration, when the inner diameter of the foamed elastic body is in the range of 30% to 85% of the outer diameter of the shaft body, the foamed elastic body is extended in the circumferential direction of the roll, that is, tensile force is exerted on the foamed elastic body in the circumferential direction of the roll. Accordingly, it is possible to improve fatigue resistance. Further, it is possible to improve cylindricality and impart good shape to the roll.

Further, when the foamed elastic body is formed of ion conductive rubber, it is possible to make electric resistance distribution uniform.

Further, since the shaft body is a solid body and gas is not removed from the shaft body when the base layer is cross-linked and foamed, the skin layer is not formed on the inner circumference of the foamed elastic body and the open foamed cells are formed on the inner circumference. Therefore, it is possible to decrease the hardness.

According to the method of manufacturing a foamed elastic body of the present invention, since the skin layer is formed, without foaming, on the outer circumference of a non-cross-linked and non-foamed tube body and then a non-cross-linked portion is foamed and cross-linked, it is possible to achieve a foamed elastic body having a skin layer on the outer circumference and open foamed cells on the inner circumference. Accordingly, it is possible to achieve a foamed elastic body having low hardness, and excellent flatness and smoothness on the outer circumference.

Further, in the step of forming the skin layer by heating the tube body with a shaft core inserted in the tube body, heat is not easily transferred to the inner circumference by the shaft core. Therefore, only the outer circumference of the tube body is heated and cross-linked, and a skin layer is formed only on the outer circumference.

Further, in the step of forming the skin layer by heating the tube body under pressure, it is possible to prevent decomposition of the foaming agent in the step of forming the skin layer, such that it is possible to form a skin layer without foamed cells.

Additional objects and advantages of the invention are set forth in the description which follows, are obvious from the description, or may be learned by practicing the invention. The objects and advantages of the invention may be realized and attained by the foamed elastic body, the method of manufacturing the same, and the conductive roll for the electrophotographic machine in the claims.

### BRIEF DESCRIPTION OF THE DRAWINGS

The accompanying drawings, which are incorporated in and constitute a part of this specification, illustrate embodiments of the present invention and, together with the description, serve to explain the objects, advantages and principles of the invention. In the drawings,

FIG. 1 is a cross-sectional view of a foamed elastic body according to a first preferred embodiment, seen in the circumferential direction; and

FIGS. 2A and 2B are cross-sectional views of a conductive roll for an electrophotographic machine according to the first preferred embodiment, seen in the circumferential direction.

### DETAILED DESCRIPTION OF THE PREFERRED EMBODIMENTS

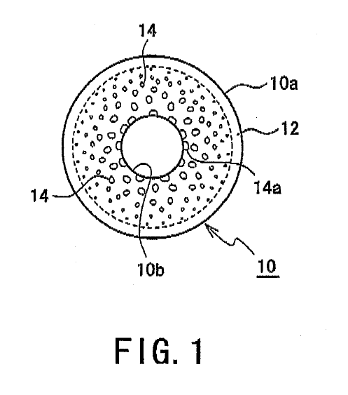

A detailed description of one preferred embodiment of a foamed elastic body embodied by the present invention is provided below with reference to the accompanying drawings. FIG. 1 is a cross-sectional view of a foamed elastic body according to a first preferred embodiment, seen in the circumferential direction. A foamed elastic body 10, for example, can be suitably used as a base layer of a conductive roll for an electrophotographic machine (hereafter, also referred to as conductive roll) or a resistance adjusting layer, etc. More preferably, the foamed elastic body 10 is used as the base layer.

As shown in FIG. 1, the foamed elastic body 10 has a tube shape and includes plural foamed cells 14. The foamed elastic body 10 is a single unit formed of one conductive composition; however, it has a skin layer 12 on an outer circumference 10a and open foamed cells 14a on an inner circumference 10b. That is, the surface of the outer circumference 10a of the foamed elastic body 10 is flattened by the skin layer 12. On the other hand, since the open foamed cells 14a are provided on the inner circumference 10b, the foamed elastic body 10 can provide high elasticity and reduce the hardness of the roll surface, when it is applied to a conductive roll. Further, although the skin layer 12 is the portion disposed outside the dotted line in FIG. 1, it may be considered as the portion without the foamed cells 14, without a clear interface with the inside (not shown as a layer).

It is preferable that the thickness of the skin layer 12 is in the range of 10 to 100 μm, considering the balance between reducing the hardness and flattening and smoothening the outer circumference. It is more preferable that the thickness of the skin layer 12 is in the range of 30 to 90 μm. When the thickness of the skin layer 12 is below 10 μm, effect of increasing the flatness and smoothness of the outer circumference can be easily decreased. On the other hand, when the thickness of the skin layer 12 is over 100 μm, increase in the hardness due the formation of the skin layer may be easily increased.

It is preferable that the surface roughness Rz of the outer circumference of the foamed elastic body 10 having the skin layer 12 is in the range of 0 to 18 μm. When the surface roughness Rz is over 18 μm, it is difficult to achieve satisfactory flatness and smoothness of the surface for obtaining a good image. Further, it is preferable that the MD-1 hardness of the foamed elastic body 10 is in the range of 20 to 34 degrees, considering reducing the hardness. Further, it is preferable that the foamed cells 14 of the foamed elastic body 10 gradually increase in diameter toward the inside in the circumferential direction, as shown in FIG. 1.

It is possible to check the thickness of the skin layer 12 and the distribution of the foamed cells 14 in the foamed elastic body 10 by observing the cross section of the foamed elastic body 10. For example, it is possible to observe the cross section of the foamed elastic body 10 using a microscope.

The foamed elastic body 10 is formed of a conductive composition. The conductive composition may be cross-linked and may not be cross-linked. Examples of a main component of the conductive composition include ethylene propylene diene rubber (EPDM), nitrile rubber (NBR), hydrin rubber (CO, ECO, etc.), silicone rubber, urethane rubber, styrene butadiene rubber (SBR), natural rubber (NR), isoprene rubber (IR), and chloroprene rubber. Among them, ethylene propylene diene rubber, nitrile rubber, and hydrin rubber are more preferable. One, or two or more components of them may be used at the same time.

It is preferable that the conductive compositions contain a foaming agent or a conductive agent (electronic conductive agent such as carbon black, ion conductive agent such as quaternary ammonium salt). Further, in addition to them, if necessary, a variety of additive agents such as filler, bulking agent, strengthening agent, processing aid, hardening agent, vulcanizing accelerator, cross-linking agent, cross-linking assistant, antioxidizing agent, plasticizing agent, ultraviolet absorbing agent, colorant, silicone oil, auxiliary agent, and interfacial active agent are appropriately added.

Further, when the foamed elastic body 10 is used, for example, for a conductive roll for an electrophotographic machine, it is preferable that the foamed elastic body 10 is formed of ion conductive rubber. This is because it makes electric resistance distribution uniform, and is advantageous, as compared with when it is formed of electronic conductive rubber.

The foam agent may be an organic foam agent and an inorganic foam agent (sodium bicarbonate, etc.). An organic foam agent is more preferable, considering that it can be easily foamed by cracking or the resolvent has good compatibility with matrix rubber. Examples of the organic foam agent include azodicarbonamide (ADCA), 4,4′-oxybishydrazide (benzene sulfonyl) (OBSH), and N,N′-dinitrosopentamethylenetetramine (DPT). One, or two or more components of them may be used at the same time.

A method of manufacturing a foamed elastic body according to the present invention is described hereafter (hereafter, also referred as the present manufacturing method). The present manufacturing method includes a step of forming a tube body, a step of forming a skin layer, and a step of foaming and cross-linking.

In the step of forming a tube body, first, the conductive composition, obtained by mixing the main component, foaming agent, conductive agent, and other necessary additive agents, is formed in a tube shape, in which the conductive composition is not cross-linked and foamed.

The forming method may be any one of extrusion molding and die forming. The extrusion molding is preferable, considering that it has good productivity. For the extrusion molding, general extruders can be used. As a method of forming the conductive composition into a tube shape by extrusion molding, for example, a method of extruding the conductive composition simultaneously with a bar-shaped or cylindrical shaft core can be used. The material of the shaft core may be metal or resin. In detail, the material for the shaft core can be, for example, iron, aluminum, and copper, etc, in which plating may be applied to the outer circumference.

Next, in the step of forming a skin layer, only the outer circumference of the tube body is cross-linked. For example, when the tube body is heated with the shaft core inserted in the tube body, heat is not easily transferred to the inner circumference by the shaft core. Therefore, only the outer circumference of the tube body is heated and cross-linked, such that a skin layer is formed only on the outer circumference.

Further, the step of forming a skin layer needs to prevent the conductive composition from being foamed. Accordingly, for example, it is preferable that the outer circumference of the tube body is cross-linked under pressure. Further, after the skin layer is formed, foaming and cross-linking can be simultaneously performed at the optimal condition by returning to normal pressure.

In the step of forming a skin layer, it is preferable that the pressure is in the range of 0.5 to 30 MPa. When the pressure is below 0.5 MPa, the effect that prevents the foam agent from foaming is easily decreased. On the other hand, when the pressure is over 30 MPa, it is difficult to control foaming inside. It is preferable that the thickness of the skin layer is in the range of 10 to 100 μm. Considering the above, it is preferable that the heating temperature is in the range of 120 to 250° C. Further, it is preferable that the heating time is in the range of 5 to 3000 seconds.

Next, in the step of foaming and cross-linking, the tube body is further heated after the skin layer is formed thereon, in which it is preferable to heat the tube body to a higher temperature than a temperature at which the cross-linking speed of the conductive composition is high and a decomposition temperature of the foam agent. Further, in order to allow the cross-linking and foaming to sufficiently proceed, it is preferable that the cross-linking and foaming are performed under normal pressure. Therefore, it is possible to foam and cross-link a non-cross-linked portion, other than the skin layer. Considering sufficiently proceeding the cross-linking and foaming, it is preferable that the heating temperature is in the range of 150 to 300° C. Further, it is preferable that the heating time is in the range of 5 to 3000 seconds.

In the step of forming a skin layer, the tube body is gradually cross-linked from the outer circumference to the inner circumference. That is, the degree of the cross-linking is higher at the outer circumference than at the inner circumference, and the cross-linking density is higher at the outer circumference than at the inner circumference. Because the cross-linking is almost finished at the outer circumference of the skin layer, foamed cells are not created there even if the foam agent is resolved in the step of foaming and cross-linking. On the other hand, because the cross-linking is half finished or does not occur on the inner side of the skin layer, foamed cells are created there when the foam agent is resolved in the step of foaming and cross-linking. The created foamed cells have diameters corresponding to the cross-linking degree. According to the present manufacturing method, it is possible to achieve a configuration in which the diameters of the foamed cells gradually increase toward the inside in the radial direction of the foamed elastic body.

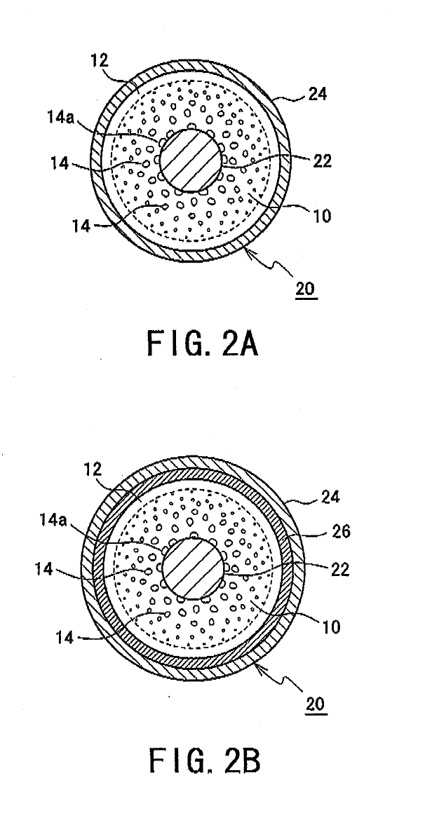

A conductive roll for an electrophotographic machine according to a preferred embodiment of the present invention is described in detail with reference to the accompanying drawings. FIGS. 2A and 2B are cross-sectional views of the conductive roll according to the preferred embodiment of the present invention, seen from the circumferential direction. A conductive roll 20 is a conductive roll that is suitably used as a charging roll, a developing roll, a transfer roll, and a toner supply roll used in an electrophotographic machine using xerography such as a copier, a printer, and a fax machine. The conductive roll 20 is disposed around a photosensitive drum provided in the electrophotographic machine.

The conductive roll 20 shown in FIG. 2A includes a conductive shaft 22 that is a shaft body, a base layer 10 formed of the foamed elastic body and provided around the outer circumference of the conductive shaft 22, a coating layer 24 coated on the outer circumference of the base layer 10 and formed of one layer. The base layer 10 is formed around the outer circumference of the conductive shaft 22 by inserting the conductive shaft 22 in the base layer 10.

In this configuration, it is preferable that the outer diameter of the conductive shaft 22 is slightly larger than the inner diameter of the tube-shaped base layer 10 before the conductive shaft 22 is inserted. In other words, it is preferable that the inner diameter of the tube-shaped base layer 10 before the conductive shaft 22 is inserted is slightly smaller than the outer diameter of the conductive shaft 22.

In detail, the inner diameter of the tube-shaped base layer 10 before the conductive shaft 22 is inserted is preferably in the range of 30% to 85% of the outer diameter of the conductive shaft 22, more preferably in the range of 35% to 83%, more preferably in the range of 40% to 80%. In theses ranges, when the conductive shaft 22 is inserted (press-fitted), the tube-shaped base layer 10 is extended in the circumferential direction of the roll, that is, tensile force is exerted in the circumferential direction of the roll of the tube-shaped base layer 10. Therefore, it is possible to improve fatigue resistance. Further, it is possible to improve accuracy of the cylinder and impart good shape to the roll.

In this configuration, when the inner diameter of the tube-shaped base layer 10 before the conductive shaft 22 is inserted is below 30% of the outer diameter of the conductive shaft 22, insertion (press-fitting) of the conductive shaft 22 becomes difficult and the base layer 10 is easily torn. On the other hand, when the inner diameter of the tube-shaped base layer 10 before the conductive shaft 22 is inserted is over 85% of the outer diameter of the conductive shaft 22, the fatigue resistance is deteriorated. Accordingly, it is preferable to pay attention to these points.

Further, since the base layer 10 is basically formed of the foamed elastic body, the detailed description is not provided here.

The conductive shaft 22 may be a core bar defined by a metallic solid body made of iron, aluminum, or copper, etc., a cylindrical metallic hollow body, or such bodies to which plating is applied. It is preferable that the conductive shaft 22 is a solid body without air holes formed through the inner circumference and the outer circumference. If necessary, an adhesion layer may be formed by applying adhesive or primer to the outer circumference of the conductive shaft 22. The adhesive or the primer may be made conductive, if necessary.

The coating layer 24 is coated on the outer circumference of the base layer 10 and defines an outermost layer of the conductive roll 20. The coating layer 24 requires a surface protection function to ensure durability, for example. Further, for example, when the conductive roll 20 is a charging roll, it requires chargeability, etc. Further, for example, when the conductive roll 20 is a developing roll, it requires toner chargeability, toner releasability, residual charge attenuation, etc. Therefore, when forming the coating layer 24, a composition corresponding to the required functions is prepared.

The main component of the composition forming the coating layer 24 may be, for example, resins such as polyamide-based resin, silicone-based resin, fluorine-based resin, polymethyl methacrylate (PMMA), polycarbonate, urethane-based resin, acrylic resin, melamine-based resin, and nylon resin, rubbers such as nitrile rubber (NBR) and epichlorohydrin rubber, and denatured substances denatured by silicone and fluorine, etc. from the resins and rubbers. One, two or more components of them may be mixed. Considering chargeability, fatigue resistance, durability, and antifouling property, etc., the polyamide-based resin, silicone-based resin, fluorine-based resin, urethane-based resin, and nylon resin are more preferable.

One, or two or more additive agents such as a conductive agent (electronic conductive agent such as carbon black, ion conductive agent such as quaternary ammonium salt), a mold-releasing agent, and a hardening agent, may be added in the coating layer 24. The blending quantity of the conductive agent may be appropriately adjusted.

The conductive roll 20 for an electrophotographic machine according to the present invention, as shown in FIG. 2B, may include two coating layers 24, 26 coated on the outer circumference of the base layer 10. Further, it may include three or more coating layers. The conductive roll requires various functions, according to the types of the conductive roll or performance required for the electrophotographic machine. Therefore, one or more coating layers are coated according to the required functions.

The conductive roll 20 shown in FIG. 2B has the coating layer 26 defining an intermediate layer inside the coating layer defining an outermost layer. The intermediate layer, for example, functions as a resistance adjusting layer. For the coating layer 26, a composition corresponding to the function required for the intermediate layer is preferably prepared.

The main component of the coating layer 26, for example, may be hydrin rubber such as homopolymer of epichlorohydrin (CO), epichlorohydrin-ethylene oxide dual copolymer (ECO), epichlorohydrin-allyl glycidyl ether dual copolymer (GCO), and epichlorohydrin-ethylene oxide-allyl glycidyl ether terpolymer (GECO), or, ethylene-propylene rubber (EPDM), styrene-butadiene rubber (SBR), polynorbornene rubber, silicone rubber, butadiene rubber (BR), isoprene rubber (IR), acrylic rubber (ACM), chloroprene rubber (CR), urethane rubber, urethane-based elastomer, fluoro-rubber, natural rubber (NR), acrylonitrile-butadiene rubber (NBR), and acrylonitrile-butadiene rubber hydride (H-NBR), etc. One, or two or more components of them may be mixed. Considering the electric resistance controllability and fatigue resistance, silicone rubber, acrylonitrile-butadiene rubber (NBR), hydrin rubber, and urethane-based elastomer are preferable.

A conductive agent (electronic conductive agent such as carbon black, ion conductive agent such as quaternary ammonium salt) may be appropriately added in the coating layer 26. Further, if necessary, a cross-linking agent, a cross-linking promoter, and a softener (oil), etc. may be appropriately added. The blending quantity of the conductive agent may be appropriately adjusted.

Since the coating layers 24, 26 are formed by coating, they can be formed thin. Therefore, it is possible to prevent an increase in the hardness and form layers having various functions. When they are not formed by coating but formed by covering with tube bodies, thickness is large and it is difficult to achieve low hardness. Accordingly, the thickness of the coating layer is preferably in the range of 0.1 to 50 μm, more preferably in the range of 0.5 to 20 μm.

The method of coating is not specifically limited, and common methods such as dipping, spraying, and roll coating can be used. The coating layer can be formed by drying, heating, and cross-linking, after the coating. The material of the coating layers may be in liquid state for coating. In this configuration, aqueous or organic solvent may be appropriately used.

It is preferable that the surface hardness (MD-1 hardness) of the conductive roll 20 is in the range of 25 to 55 degrees. The roll surface is excessively softened when the surface hardness is below 25 degrees. Accordingly, for example, in a developing roll, a toner can easily penetrate and causes filming. On the other hand, when the surface hardness is over 55 degrees, a counterpart member that comes into contact with the roll surface or the toner is easily stressed, thereby easily deteriorating the image during the endurance time.

It is preferable that the volume resistance of the conductive roll 20 is in the range of 1×10³ to 1×10⁸Ω. When the volume resistance is below 1×10³Ω, the volume ratio of the conductive agent increases and it is difficult to obtain sufficient withstand pressure. On the other hand, when the volume resistance is over 1×10⁸Ω, the volume ratio of the conductive agent decreases and irregularity of resistance can be easily generated.

When forming the conductive roll 20, the conductive shaft 22 is inserted into the tube-shaped base layer 10 formed of the foamed elastic body manufactured by the method of manufacturing the foamed elastic body, and then the coating layer 24 is coated on the outer circumference of the base layer 10. If the coating layer 26 is included, the coating layer 26 is formed and then the coating layer 24 is coated on the outer circumference of the coating layer 26.

### EXAMPLES

The present invention is described hereafter in detail with reference to Examples.

[Raw Material]
EPDM (Esprene 505/made by Sumitomo Chemical Co. Ltd.)
NBR (NIPOL DN3335/made by Zeon Corporation)
Hydrin rubber (Epichlomer CG102/made by DAISO CO., LTD.)
Carbon black (Ketjenblack EC/made by Ketjenblack International)
Quaternary ammonium salt (tetramethylammoniumperchlorate)
Zinc oxide (zinc oxide two type/made by Sakai Chemical Industry Co., Ltd.)
Stearic acid (Runac S30/made by Kao Corporation)
Process oil (Diana Process PW380/made by Idemitsu Kosan Co., Ltd.)
ADCA (foaming agent) (azodicarbonamide/made by Eiwa Chemical Ind. Co., Ltd.)
OBSH (foaming agent) (4,4-oxybisbenzenesulfonylhydrazide/made by Eiwa Chemical Ind. Co., Ltd.)
Sulfur (made by Karuizawa Seiren Co., Ltd.)
Vulcanization accelerator 1 (dibenzo thiazole disulfide)
Vulcanization accelerator 2 (Tetramethylthiuram monosulfide)
Nylon (Tresin EF30T/made by Nagase Chemlock)

<Preparation of Base Layer Composition>

Conductive compositions of combination examples 1 to 9 shown in Table 1 were prepared.

TABLE 1

| | | Comb. | Comb. | Comb. | Comb. | Comb. | Comb. | Comb. | Comb. | Comb. |
|---|---|---|---|---|---|---|---|---|---|---|
| | | Example 1 | Example 2 | Example 3 | Example 4 | Example 5 | Example 6 | Example 7 | Example 8 | Example 9 |
| Components | EPDM | 100 | 100 | | | 100 | | 100 | | |
| (parts by weight) | NBR | | | 100 | | | | | | 100 |
| | Hydrin rubber | | | | 100 | | 100 | | 100 | |
| | Carbon black | 25 | 25 | 20 | | 30 | | 10 | | |
| | Quaternary | | | | 1 | | 2 | | 1 | 2 |
| | ammonium salt | | | | | | | | | |
| | Zinc oxide | 5 | 5 | 5 | 5 | 5 | 5 | 5 | 5 | 5 |
| | Stearic acid | 1 | 1 | 0.5 | | 1 | 2 | 1 | | 0.5 |
| | Process oil | 30 | 30 | | | 40 | | 30 | | |
| | ADCA | 15 | | | 10 | 15 | | 15 | 10 | 10 |
| | (foaming agent) | | | | | | | | | |
| | OBSH | | 12 | 12 | | | | | | |
| | (foaming agent) | | | | | | | | | |
| | Sulfur | 1 | 1 | 1 | 1 | 1 | 1 | 1 | 1 | 1 |
| | Vulcanization | 1.5 | 1.5 | 1.5 | 1.5 | 1.5 | 1.5 | 1.5 | 1.5 | 1.5 |
| | accelerator 1 | | | | | | | | | |
| | Vulcanization | 1 | 1 | 1 | 1 | 1 | 1 | 1 | 1 | 1 |
| | accelerator 2 | | | | | | | | | |

<Preparation of the Outermost Layer Coating Liquid>

An outermost layer coating liquid was prepared by adding nylon of 100 parts by weight and carbon black of 8 parts by weight to methanol of 400 parts by weight, and mixing them.

### 1. Experiment 1

### Example 1

A composite body was formed by extruding the conductive composition of combination example 1 simultaneously with a shaft core (diameter 6 mm, SUS304) by an extruder, and coating a non-cross-linked and non-foamed tube body on the outer circumference of the shaft core. The obtained composite body was inserted in a pressurizing oven, heated at 200° C. for 15 minutes under 3 Mpa pressure, and then the rubber surface was cross-linked while preventing foaming. Thereafter, a tube body was obtained by removing the shaft core from the composite body and then the obtained tube body was heated at 200° C. for 30 minutes under normal pressure, and then cross-linked and foamed. As a result, a foamed tube body having a skin layer on the outer circumference and open foamed cells on the inner circumference was obtained.

A roll body was manufactured by inserting a conductive shaft (diameter 6 mm, length 270 mm) into the obtained foamed tube body (thickness 1.5 mm). The outermost layer coating liquid was coated on the outer circumference of the foamed tube body of the obtained roll body, and the outermost layer having 15 μm thickness was obtained by drying the roll body at 100° C. for 30 minutes. The conductive roll according to Example 1 was manufactured as described above.

### Examples 2 to 4

Conductive rolls according to Examples 2 to 4 were manufactured by the same method as Example 1, except that conductive compositions of combination examples 2 to 4 were used, instead of the conductive composition of combination example 1.

### Comparative Example 1

A composite body was formed by extruding the conductive compositions of combination examples 5 and 6 using an extruder, simultaneously with a conductive shaft (diameter 6 mm, SUS304), and then covering the outer circumference of the conductive shaft with two rubber layers. The obtained composite body was inserted into a tube-shaped mold (diameter 9.0 mm, SUS304) and heated at 160° C. for 30 minutes, and the inner layer of the rubber layers was cross-linked and foamed. As a result, a roll body (inner layer thickness 1 mm and outer layer thickness 0.5 mm) was manufactured. Thereafter, in the same method as Example 1, an outermost layer having 15 μm thickness was formed. A conductive roll according to Comparative Example 1 was manufactured as described above.

### Comparative Example 2

A composite body was formed by extruding the conductive composition of combination example 4 simultaneously with a conductive shaft (diameter 6 mm, SUS304) using an extruder, and then coating a non-cross-linked and non-foamed tube body on the outer circumference of the conductive shaft. The obtained composite body was inserted in a tube-shape mold (diameter 9.0 mm, SUS304) and heated at 160° C. for 30 minutes, and the tube body was cross-linked and foamed. As a result, a roll body (thickness of rubber layer 1.5 mm) was manufactured. Thereafter, in the same method as Example 1, an outermost layer having 15 μm thickness was formed. A conductive roll according to Comparative Example 2 was manufactured as described above.

### Comparative Example 3

A conductive roll according to Comparative Example 3 was manufactured in the same method as Comparative Example 2, except that a tube-shaped metallic mold having air permeability and diameter 9.0 mm was used to heat a composite body, instead of the tube-shaped mold (diameter 9.0 mm, SUS304) in Comparative Example 2.

### Comparative Example 4

A conductive roll according to Comparative Example 4 was manufactured in the same method as Comparative Example 2, except for extrusion simultaneous with a metallic shaft having air permeability and diameter 6 mm, instead of the conductive shaft (diameter 6 mm, SUS304) in Comparative Example 2. That is, in the conductive roll according to Comparative Example 4, the conductive shaft is formed of metal having air permeability.

### Comparative Example 5

A conductive roll according to Comparative Example 5 was manufactured in the same method as Comparative Example 2, except that a composite body was aged under a dry-heat environment at 60° C. for 24 hours and heated at 160° C. for 30 minutes.

<Examination for Each Conductive Roll>

For the conductive rolls according to Examples 1 to 4 and Comparative Examples 1 to 5, the surface property and the hardness were examined in accordance with the following examination method. Further, MD-1 hardness was measured. The result is shown in Table 2. In addition, comparison of manufacturing processes is shown in Table 2.

(Examination of Surface Property)

Each of the conductive rolls was set, as a charging roll, in a color laser printer (Color Laser Jet 3800dn, made by HP), which is on the market, and 25% half-tone images were outputted under 15° C.×10% RH environment. Conductive rolls of output images without black spot defects thereon were indicated by “∘”, conductive rolls of output images with slight black spot defects thereon were indicated by “Δ”, and conductive rolls of output images with considerable black spot defects thereon were indicated by “x”.

(Examination of Hardness)

Each of the conductive rolls was set, as a charging roll, in a color laser printer (Color Laser Jet 3800dn, made by HP), which is on the market, and outputted under 15° C.×10% RH environment, for a long time at 5% concentration to the life span of a cartridge. Conductive rolls without toners fused and bonded to the surface of the photosensitive drum and the surface of the conductive roll after long time use were indicated by “∘”, conductive rolls with toners fused and bonded to the surface of the photosensitive drum and the surface of the conductive roll after long time use but without changes in the outputted images were indicated by “Δ”, and conductive rolls with toners fused and bonded to the surface of the photosensitive drum and the surface of the conductive roll after long time use and outputted images exposed were indicated by “x”.

(MD-1 Hardness)

The surface hardness of each of the conductive rolls was measured (N=3) by a MD-1 hardness tester (Micro Compact Hardness Tester MD-1 type, made by KOBUNSHI KEIKI Co, LTD.).

TABLE 2

| | | Example | | | | Comparative Example | | | | |
|---|---|---|---|---|---|---|---|---|---|---|
| | | 1 | 2 | 3 | 4 | 1 | 2 | 3 | 4 | |
| | | Heating under | | | | Covering with | Single layer | Mold with air | Shaft with air | 5 |
| | | pressure | | | | layer | with foaming | permeability | permeability | Aging |
| Manufacturing | Mold | Unnecessary | | | | Necessary | Necessary | Specific | Necessary | Unnecessary |
| process | Covering with layer | Unnecessary | | | | Necessary | Unnecessary | Unnecessary | Unnecessary | Unnecessary |
| | Aging | Unnecessary | | | | Unnecessary | Unnecessary | Unnecessary | Unnecessary | Necessary |
| Examination | Surface property | ◯ | ◯ | ◯ | ◯ | ◯ | X | Δ | X | Δ |
| | (image property) | | | | | | | | | |
| | Hardness | ◯ | ◯ | ◯ | ◯ | Δ | ◯ | ◯ | ◯ | Δ |
| | (image property after | | | | | | | | | |
| | long time use) | | | | | | | | | |
| | MD-1 hardness | 25 | 25 | 25 | 25 | 45 | 25 | 25 | 25 | 35 |
| | (degree) | | | | | | | | | |

In Comparative Example 1, a foam rubber layer is covered with a non-foam rubber layer. Accordingly, the hardness of the roll surface becomes high and image defects were generated after long time use. Further, in Comparative Example 1, a process for covering with the rubber layer was needed, such that the process became complicated, thereby increasing the manufacturing cost. Furthermore, since a mold was used, the manufacturing cost increases.

In Comparative Example 2, the base layer is formed of simple foam rubber. Accordingly, open foamed cells were formed on the outer circumference of the base layer and the unevenness of the surface increased. Therefore, the surface property is deteriorated and image defects were generated. Further, since a mold was used, the manufacturing cost increases.

In Comparative Example 3, a specific mold made of metal having air permeability is used and the base layer is foamed while removing gas from the mold. The conductive roll having the obtained base layer was poor in image property and surface property. Further, since a specific mold was required, the manufacturing cost increases.

In Comparative Example 4, a specific shaft formed of metal having air permeability was used and the base layer was foamed while removing gas. The conductive roll having the obtained base layer was poor in image property and surface property. Further, since a specific shaft was required, the manufacturing cost increases. In addition, since a mold was used, the manufacturing cost increases.

In Comparative Example 5, after performing low-temperature aging on a rubber layer before cross-linking and foaming, for 24 hours, the base layer was foamed. The conductive roll having the obtained base layer had high roll surface hardness and image defects after long time use were generated. Further, since aging was required, productivity is low.

On the other hand, the base layer of each of the conductive rolls according to Examples 1 to 5 has a skin layer on the outer circumference and open foamed cells on the inner circumference, such that the base layer has low hardness and good flatness and smoothness on the outer circumference. Since the flatness and smoothness of the outer circumference were good, it is possible to form coating layers having various functions on the outer circumference. The conductive rolls having the above base layer have good image property and good image property after long time use. Therefore, it can be seen that the conductive rolls according to Examples 1 to 5 have low hardness and good surface property. Further, manufacturing cost is not increased and productivity is good.

### 2. Experiment 2

### Examples 5 to 11

Composite bodies were formed by extruding conductive compositions of combination examples 7 to 9 simultaneously with shaft cores having different diameters (diameter 2 to 6 mm, SUS304) using an extruder and applying non-cross-linked and non-foamed tube bodies on the outer circumferences of the shaft cores, respectively. The obtained composite bodies were inserted in a pressure oven and heated at 150° C. for 15 minutes under 1 MPa pressure, and the rubber surfaces were cross-linked while preventing foaming. Thereafter, tube bodies obtained by removing the shaft cores from the composite bodies were heated at 150° C. for 30 minutes under normal pressure, and cross-linked and foamed. As a result, foamed tube bodies (Examples 5 to 11) each having a skin layer on the outer circumference and open foamed cells on the inner circumference were obtained.

Roll bodies were manufactured by inserting a conductive shaft (diameter 6 mm and length 270 mm) into the obtained foamed tube bodies (thickness 1.5 mm). An outermost layer coating liquid was applied to the outer circumference of the foamed tube body of each of the obtained roll bodies and dried at 120° C. for 30 minutes, and an outermost layer having 15 μm thickness was formed. Conductive rolls according to Examples 5 to 11 were manufactured as described above.

Further, in the same method, a foamed tube body having an inner diameter of 1.5 mm was manufactured, and it was tried to insert a conductive shaft having an outer diameter of 6 mm into the tube, but it was difficult.

<Examination of Each Conductive Roll>

For the conductive rolls according to Examples 5 to 11, electric resistance distribution, irregularity of the circumferences of the images, and fatigue resistance were examined as described below. Further, for reference data; MD-1 hardness and Asker-C hardness were measured. The result is shown in Table 3.

(Measurement of Electric Resistance Distribution)

The circumference of a rotary disk electrode having 5 mm in thickness was pressed onto the conductive roll by load of 35 g, with the axial direction of the rotary disk electrode aligned with the surface of the conductive roll. In this state, direct voltage of −200V was applied to the conductive shaft rotating the conductive roll at the number of revolutions of 60 rpm. Thereafter, the rotary disk electrode was moved at 5 mm/sec in the axis direction of the conductive roll and the roll surface was brought in entire surface contact in a spiral shape. During the above process, the current that has flown through the conductive roll was recorded and the electric resistance distribution was calculated as the number of digits, using the following formula 1, from the maximum value: α and the minimum value: β.

Electric Resistance Distribution=Log₁₀(α/β) Formula 1

(Irregularity on Circumference of Image)

Each of the conductive rolls was, as a charging roll, set in a color laser printer (Color Laser Jet 3800dn, made by HP), which is on the market, and images of solid black and 25% half tone were outputted. In the obtained images, images without image concentration irregularity in the roll pitch were indicated as “excellent”, images with slight image concentration irregularity in the roll pitch were indicated as “good”, and images with clear image concentration irregularity in the roll pitch were indicated as “bad”.

(Fatigue Resistance)

Each of the conductive roll was, as a charging roll, set in a color laser printer (Color Laser Jet 3800dn, made by HP), which is on the market, left for one week under RH environment of 40° C.×95%, and then images of 25% half tone were outputted. In the obtained images, images without image streaks in the roll pitch were indicated as “excellent”, images with slight image streaks in the roll pitch were indicated as “good”, and images with clear image streaks in the roll pitch were indicated as “bad”.

TABLE 3

| | Example | | | | | | |
|---|---|---|---|---|---|---|---|
| | 5 | 6 | 7 | 8 | 9 | 10 | 11 |
| Components of foamed tube body | Comb. | Comb. | Comb. | Comb. | Comb. | Comb. | Comb. |
| | Example 7 | Example 8 | Example 8 | Example 8 | Example 8 | Example 8 | Example 9 |
| Outer diameter of shaft (mm) | 6 | 6 | 6 | 6 | 6 | 6 | 6 |
| Inner diameter of tube before shaft is inserted (mm) | 6 | 5.4 | 5 | 4 | 3 | 2 | 4 |
| Proportion of inner diameter of tube to outer | 100% | 90% | 83.3% | 66.7% | 50.0% | 33.3% | 66.7% |
| diameter of shaft before shaft is inserted | | | | | | | |
| MD-1 hardness (degree) | 43.1 | 39.7 | 39.2 | 38.0 | 37.1 | 36.9 | 39.2 |
| Asker-C hardness (degree) | 77.9 | 66.8 | 66.2 | 65.9 | 64.7 | 64.9 | 66.3 |
| Electric resistance distribution | 0.7 | 0.08 | 0.08 | 0.07 | 0.06 | 0.09 | 0.13 |
| (the number of digits) | | | | | | | |
| Irregularity on circumference of image | bad | excellent | excellent | excellent | excellent | excellent | excellent |
| Fatigue Resistance | excellent | bad | excellent | excellent | excellent | excellent | excellent |

NOTE:
The inner diameter of the tube before the shaft is inserted is equal to the outer diameter of the shaft core used in the extrusion.

The followings can be seen by relatively comparing Table 3. It is seen that the fatigue resistance was improved in Examples 7 to 11, as compared with Example 6. This is because each of the foamed tube body was extended in the circumferential direction of the roll, that is, tensile force was exerted on the foamed tube body in the circumferential direction of the roll and resilience was increased, by inserting the conductive shaft into the foamed tube body having an inner diameter in the range of 30% to 85% of the outer diameter of the conductive shaft (Examples 7 to 11). Further, in all of Examples 7 to 11, cylindricality was high and the roll shapes were good.

Further, irregularity on the circumference of the images was less generated in Examples 7 to 11, as compared with Example 5. This is because the foamed tube bodies according to Examples 7 to 11 were formed of ion conductive rubber and it was possible to make the electric resistance distribution uniform.

The foregoing description of the preferred embodiments of the invention has been presented for purposes of illustration and description. It is not intended to be exhaustive or to limit the invention to the precise form disclosed, and modifications and variations are possible in the light of the above teachings or may be acquired from practice of the invention. The embodiments chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of manufacturing a foamed elastic body for a conductive roll for an electrophotographic machine, comprising the steps of:
forming a non-cross-linked and non-foamed tube body;
forming a skin layer without a foamed cell by cross-linking an outer circumference of the tube body, without foaming; and
foaming and cross-linking a non-cross-linked portion after the step of forming the skin layer.

2. The method of manufacturing a foamed elastic body according to claim 1, wherein, in the step of forming the skin layer, the tube body is heated with a shaft core inserted in the tube body.

3. The method of manufacturing a foamed elastic body according to claim 2, wherein, in the step of forming the skin layer, the tube body is heated under pressure.

4. The method of manufacturing a foamed elastic body according to claim 3, wherein the tube body is heated in the step of foaming and cross-linking.

5. The method of manufacturing a foamed elastic body according to claim 4, wherein the tubed body is heated under normal pressure in the step of foaming and cross-linking.

6. The method of manufacturing a foamed elastic body according to claim 5, wherein the method comprises a step of inserting a shaft into the tube body after the step of foaming and cross-linking.

7. The method of manufacturing a foamed elastic body according to claim 2, wherein the shaft core is removed before the step of foaming and cross-linking.

8. The method of manufacturing a foamed elastic body according to claim 7, wherein the tube body is heated in the step of foaming and cross-linking.

9. The method of manufacturing a foamed elastic body according to claim 8, wherein the tubed body is heated under normal pressure in the step of foaming and cross-linking.

10. The method of manufacturing a foamed elastic body according to claim 9, wherein the method comprises a step of inserting a shaft into the tube body after the step of foaming and cross-linking.

11. The method of manufacturing a foamed elastic body according to claim 2, wherein the tube body is heated in the step of foaming and cross-linking.

12. The method of manufacturing a foamed elastic body according to claim 11, wherein the tubed body is heated under normal pressure in the step of foaming and cross-linking.

13. The method of manufacturing a foamed elastic body according to claim 1, wherein, in the step of forming the skin layer, the tube body is heated under pressure.

14. The method of manufacturing a foamed elastic body according to claim 13, wherein the tube body is heated in the step of foaming and cross-linking.

15. The method of manufacturing a foamed elastic body according to claim 14, wherein the tubed body is heated under normal pressure in the step of foaming and cross-linking.

16. The method of manufacturing a foamed elastic body according to claim 1, wherein the tube body is heated in the step of foaming and cross-linking.

17. The method of manufacturing a foamed elastic body according to claim 16, wherein the tubed body is heated under normal pressure in the step of foaming and cross-linking.

18. The method of manufacturing a foamed elastic body according to claim 1, wherein the method comprises a step of inserting a shaft into the tube body after the step of foaming and cross-linking.
